(19) United States
(12) Patent Application Publication
(10) Pub. No.: US 2014/0278502 A1
(43) Pub. Date: Sep. 18, 2014

(54) CLINIC MANAGEMENT SYSTEM

(71) Applicant: Bryan Laskin, Wayzata, MN (US)

(72) Inventor: Bryan Laskin, Wayzata, MN (US)

(21) Appl. No.: 14/212,897

(22) Filed: Mar. 14, 2014

Related U.S. Application Data
(60) Provisional application No. 61/787,106, filed on Mar. 15, 2013.

(51) Int. Cl. G06Q 50/22; G06Q 10/10

(52) U.S. Cl. CPC G06Q 50/22; G06Q 10/10
USPC 705/2

(57) ABSTRACT

A clinic management system may include a computing device including a clinic identifier, a list of location-based devices in the clinic, a list of role-based users affiliated with the clinic, and a user interface configuration with a one-touch interactive icon for each role-based user, a message generation area, a messaging display area, and an algorithm for facilitating communication between the location-based devices and the computing device where the computing device also includes a processor for processing downloads of user interfaces and the interfaces may be based on the stored user interface configuration, setup information provided by the clinic, a selected location-based device, and at least a portion of the role-based users and when a one-touch interactive icon is selected for a role-based user, a message is generated and displayed calling the role-based user to the location associated with the message.

### CROSS-REFERENCE TO RELATED APPLICATIONS

The present application claims priority to U.S. Provisional Application No. 61/787,106 filed on Mar. 15, 2013 entitled paging system, the content of which is hereby incorporated by reference herein in its entirety.

### FIELD OF THE INVENTION

The present disclosure relates to systems and methods for facilitating fast communication between a selected set of persons and/or devices. In particular, the disclosure includes discussion of a computer implemented system for quickly contacting (e.g., paging) a co-worker, physician, support person, service technician or other person, thing, or entity, and requesting action by or notifying the person, thing, or entity. Still more particularly, the disclosure includes discussion of a paging system adaptable for use with smartphones, laptops, pad-type computers, desktop computers, or other computing devices having the ability to log in to a system via a network connection.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Dental and medical professionals and their staff commonly rely on pagers worn by the physician such that the physician can be called, summoned, or otherwise contacted in several situations. In the dental setting, a dentist may wear a pager and may be paged by hygienists when a patient teeth cleaning is finished or when a problem is encountered by a hygienist. Other situations often arise for a dentist to be paged such as when he or she is away from the office or dental facility and emergencies or other events call for the dentist to return to the facility. In still other situations, a dentist may be away from the office, but may be on-call, for example, and a page may be sent to the dentist such that the dentist may call a patient or such that the dentist may return to the office for a consultation and/or procedure. Similar situations arise in the medical field where a doctor, physician assistant, or nurse practitioner may need to be contacted.

Current paging systems include small screen pagers worn by a physician. A person needing to contact the physician may dial a phone to reach a paging system, enter the physician's paging number and potentially enter or leave a message. Other systems that can be used to reach a physician include mobile phones, text messaging, e-mail, instant messaging and the like. The above systems are cumbersome and are not amenable to tailoring to a particular setting or for particular purposes.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In some embodiments, a clinic management system may include a computing device in communication with a network and comprising a computer readable storage medium with a plurality of data structures. The data structures may include a clinic identifier, a list of location-based devices in the clinic, a list of role-based users affiliated with the clinic, and a user interface configuration. The user interface configuration may include a one-touch interactive icon for each role-based user, a message generation area allowing detailed messages to be sent to a location-based device, a messaging area for displaying messages sent by the system, and an algorithm for facilitating communication between the location-based devices. The computing device may also include a processor configured for processing downloads over the network of user interfaces for at least a portion of the location-based devices in the list of location-based devices. The user interfaces may be based on the stored user interface configuration, setup information provided by the clinic, a selected location-based device, and at least a portion of the role-based users. When a one-touch interactive icon is selected for a selected role-based user, a message is generated on at least one location-based device calling the role-based user to the location associated with the message and the message may be displayed on the location-based device.

In another embodiment, a method of managing a clinic may include uploading, over a network and for download by a computing device, an interface. The method may also include communicating with the computing device to receive inputs from the interface and send outputs for display on the interface. The interface may be for a location-based device and it may include a plurality of interactive icons for each of a plurality of role-based users. The interface may also include a messaging area for displaying messages sent by the system and an indication of which location-based device the interface is being displayed on. The method may also include associating a role-based user with at least one location-based device and receiving a selection of one of the interactive icons. The method may also include compiling a message directed toward the at least one location-based device that is associated with the selected interactive icon and displaying the message on the at least one location-based device.

In another embodiment, a method of managing a clinic may be provided where the method is performed by a first user having a role in the clinic and is performing that role at a first location. The method may include accessing a network with a computing device, navigating to and logging into a website of a clinic management system, and selecting a location-based device from a list of location-based devices. The method may also include using an interface having a plurality of interactive icons associated with other users in the clinic to request a second user to report to the first location and to send a verbal message to one or more users. The portion of the method relating to requesting a second user to report to the first location may consists solely of selecting an interactive icon associated with the second user. That is, a single touch of an icon may generate the message and display the message on one or more location-based devices.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of a clinic management system, according to some embodiments.

FIG. 2 is a one embodiment of the system of FIG. 1, according to some embodiments.

FIG. 3A is a login interface of the system of FIG. 1, according to some embodiments.

FIG. 3B is another login interface of the system of FIG. 1 for associating with a device, according to some embodiments.

FIG. 4 is a communication interface of the system of FIG. 1, according to some embodiments.

FIG. 5 is a selection portion of the interface of FIG. 4 as it may appear on a smartphone, according to some embodiments.

FIG. 6 is a selection and display portion of the interface of FIG. 4 as it may appear on a smartphone, according to some embodiments.

FIG. 7 is a message center portion of the interface of FIG. 4 as it may appear on a smartphone, according to some embodiments.

FIG. 8 is a worksheet portion of the interface of FIG. 4, as it may appear on a smartphone, according to some embodiments.

FIG. 9 is a device entry interface of the system of FIG. 1.

FIG. 10 is a device table showing the data structures of the location-based devices of the system of FIG. 1

FIG. 11 is a role-based user entry interface of the system of FIG. 1.

FIG. 12 is a pre-written message entry interface of the system of FIG. 1.

FIG. 13 depicts a series of method steps that may be performed by the system of FIG. 1.

FIG. 14 depicts a method of use of the system of FIG. 1.

FIG. 15 depicts a schematic diagram of data structures that may be used in the system of FIG. 1, according to some embodiments.

### DETAILED DESCRIPTION

The present application, in some embodiments, is a dedicated clinic management or communication system. In some particular implementations, the system may be adapted for use by a dentist's office, for example, to facilitate communication, monitoring, and/or tracking within the office. The system may include a series of interfaces particularly adapted to manage the type of communication occurring in a dentist's office. For example, a messaging interface may be provided with a series of interactive icons or avatars for each role (i.e., dentist, hygienist, assistant, etc.) in the office allowing for quickly contacting another person. The system may be used by a hygienist, for example, to quickly send a message to a dentist to review a patient's teeth after a cleaning. In other embodiments, the lab may send a message to a dentist notifying the dentist that a lab process or analysis is complete. In other embodiments, a sterilization lab may send a message notifying a staff person or other individual that a sterilization process is complete and that tools or fixtures are available. In some embodiments, the message may include a listing of the several messages being sent throughout the office including messages not sent or received by a particular user. Still other interfaces and messaging processes may be included.

The system may be a cloud-based system allowing users of the system to easily implement the system within their offices by creating an account and setting up their account to reflect the facilities in the office together with the roles that will be performed and supported by using the system. The system may be configured to accommodate a wide variety of computing devices such that use of the system may be conducted irrespective of the type of device a user has available. As such, a dentist may bring a smartphone to the office on one occasion and may bring a tablet computer on another occasion. Once the system is accessed with the respective device, the system may functionally adapt or adjust to suitably display selected interfaces on the device.

Referring now to FIGS. 1 and 2, the system 100 may include a server 102 configured to allow a clinic office 50, such as a dentist's office, to be managed over a network 52, such as the Internet, for example. The server 102 may be connected to the network 52 and may include a computer readable storage medium 104 in communication with a processor 106 that has data and the clinic management program applications stored thereon for implementing the clinic management system 100. Accordingly, the server 102 may be accessed over the network 52 from remote locations and the system 100 may be adapted to support one or a plurality of clinics 50 simultaneously. For example, as shown, the system 100 may be configured to support multiple dentist, medical, veterinary, or other types of offices 50 where fast and efficient communication between team members is desired.

FIG. 2 shows a more detailed view of the system 100 in support of a dental practice, for example. As shown, the system 100 may be accessed by one or more devices 54 associated with the practice and may rely on the system 100 for fast and efficient communication. The devices may access the system 100 by connection to a network 52 such as through a hardwired connection to a computer network 52 in the clinic setting that, in turn, is in communication with a wider network 52, such as the Internet. The devices 54 may also be in communication with a Wi-Fi network within or near the clinic setting that may provide access the network 52. In still other embodiments, the devices 54, such as, for example a portable digital device or smartphone, may be in communication with the network 52 via wireless connection provided by a wireless provider. Still other systems and devices may be used to place a computing device 54 in communication with the network 52 allowing the users to access the system 100.

The system 100 may be particularly configured for supporting multiple clinic settings 50 simultaneously and, as such, may include a plurality of data structures stored on the computer readable storage medium 104. For example, the system 100 may include client data structures for identifying clients and for adapting the system 100 to be consistent with the client's practice. The system 100 may also include data structures relating to the user interfaces and customized versions of the interfaces that may be used to setup, navigate, customize, use, or otherwise interact with the system 100. Still further the system 100 may include data structures defining the several algorithms performable by the system 100 in response to user interaction with the user interfaces.

Regarding the client data structures, the system 100 may include a client identifier for each client 50 that is being serviced. The client or clinic 50 identifier may be the name of a client or clinic or the identifier may be a particular number, code, or other identifying element. The client or clinic identifier may allow for the system 100 to maintain each client or clinic information in isolation from one another for purposes of the functionality discussed below or for customization or for other purposes such as security and/or confidentiality.

For each client 50, the system 100 may also include data structures identifying a plurality of location-based devices 108 and a plurality role-based users 110 of the clinic 50. A location-based device 108 may be a device or interface that is associated with a particular location in the dental practice or other clinic setting 50. For example, a particular dental practice 50 may have the following location-based devices: doctor's office 108A, front desk 108B, operatory I 108C, operatory II 108D, sterilization 108E, lab 108F, etc. It is to be appreciated that each particular clinic 50 may be arranged slightly differently. As may be appreciated, any number of these locations may be present in a given practice depending on its size and organization. Accordingly, the system 100 may include a location-based device 108 for particular locations within a given client/clinic's practice and the number and type of location-based devices 108 may be customizable by the user to coincide with the users clinic organization. A location-based device 108 may not define the physical type of computing device (i.e., desktop, laptop, smartphone), but instead may define the location that a particular device (i.e., desktop, laptop, smartphone) is being used in association with. In the example shown in FIG. 2, the user may configure the settings for this clinic 50 to include one doctor's office device 108A, two operatory devices 108C/D, one lab device 108F, one sterilization device 108E, and one front desk device 108B. Still other numbers and types of location-based devices 108 may be defined for a given practice.

The system 100 may provide a series of data features associated with each of the location-based devices 108 for purposes of organizing and allowing the several devices 108 to communicate with the system 100. For example, for each location-based device 108, the system 100 may store a device name, a device type, a short name for the device, an icon color, and an icon. In the example of FIG. 2, for example, the doctor's office location-based device 108A may have a name of “doctor's office,” a device type of “iphone,” a short name of “DOCO,” and icon color of orange, and an icon of a solid orange square. These particular data features associated with the location-based devices 108 may be supplied by the user and, as such, may be tailored to accommodate a particular practice's size and organization. Additional or fewer data features may be used depending on the overall system 100 and the desired interaction between the devices 108. For example, in some embodiments, the system 100 may be adapted to recognize the type of computing device that is accessing the system 100 and automatically adjust or modify the interfaces accordingly based on screen size.

In addition to the location-based devices 108, as mentioned, the system 100 may also include data structures storing information relating to the roles in the clinic 50 by storing a series of role-based users 110. For example, and again with reference to FIG. 2, the system 100 may store role-based users such as doctor Bob 110A, hygienist I 110B, hygienist II 110C, assistant 100D, lab technician 110E, sterilization technician 110F, and the like. As with the location-based devices 108, the role-based users 110 may be selected and changed according to a particular practice size and/or organization.

Like the location-based devices 108, the system 100 may store a series of data features associated with each of the role-based users 110. For example, for each role-based user 110, the system 100 may store a name, a short name, an icon color, an avatar or icon design, and a series of location-based devices 108. In the example of FIG. 2, for example the doctor's role-based user 110A may have a name of “Doctor Bob,” a short name of DOCB, and icon color of green, an avatar or icon design reflecting a male-type design or other design reflecting a doctor's role, an alert tone, and the series of location-based devices 108 may include front desk 108B, operatory I 108C, operatory II 108D, and doctor's office 108A. The series of location-based devices 108 associated with a role-based user 110 may define the devices that the user wants to receive broadcast-type messages or pages from the system 100.

The location-based devices 108 and role-based users 110 may be associated with each client 50 and its client identifier such that the user interfaces that are used by the system 100 may be adapted to reflect an accurate representation of the particular client 50. Accordingly, when a user from the clinic 50 shown in FIG. 2 logs into the system 100, the interface may reflect this list of location-based devices and role-based users 110. As such, the interface is customizable on a system 100 level to reflect the organization and/or setup preferred or used by a particular clinic or client 50.

Continuing with the information relating to a particular client 50, each client 50 in the system 100 may include a list of users (not to be confused with role-based users) and each user for a given client may have a unique user name and password combination. In other embodiments, each client or clinic 50 may have a single user name and password that each user at that client 50 or clinic may use. In either case, the system 100 may be able to control who has access to the system 100. In addition, upon logging into the system 100, the user may be prompted to select a location-based device 108 such that the interface they are viewing is consistent with the location they are positioned at and fulfilling for that day, work period, or logged on session. That is, the interface, in addition to being customizable on a system 100 or client-based level by setting up location-based devices 108 and role-based users 110, may also be customized based on a selected location-based device 108. In some embodiments, depending on the level of information being provided at login, there may be restrictions on which users may select which devices 108.

In addition to client related data structures, the system 100 may also include data structures defining user interface configurations. That is, the system 100 may include generic interface data structures. In addition, as discussed above, since each client 50 may go through a set up process of arranging particular location-based devices 108 and particular role-based users 110, the generic interface becomes customized on a client-based level, which is stored by the system 100 on an ongoing basis as ongoing customization occurs. As such, the system 100 may maintain generic data structures for use by additional clients while also storing customized data structures for each client 50. Still more particularly, each location-based device 108 within the system 100 and role-based user 110, may have particular settings that may be continually changed and adjusted to customize a user's experience and as such, the system 100 may provide customization on a user-based level within the client-based level of customization. The several interfaces and the customization will now be described.

As shown in FIG. 3A, a logon interface 112 may be provided. This logon interface 112 may include an input field 114 for entering a user name and an input field 116 for entering a password. In some embodiments, a check box for 118 allowing the system 100 to remember the user name and password may be available. This particular interface 112 may be generic to all clients/users 50 since it is presented before verifying the user's identity, for example. Upon logging in, as shown in FIG. 3B, the user may be prompted to select the location-based device 108 they are representing. Accordingly, upon logging in, a user may become associated with a particular location-based device 108 within the clinic setting 50. In some embodiments, the user interface associated with the selected location-based device 108 may be downloaded upon logging in and selecting a particular location-based device 108. The downloaded interface may reflect the client level customization of the clinic 50 in that it may show the corresponding location-based devices 108, the corresponding role-based users 100, and it may reflect any worksheets available for sending messages. Still other types of client-level customization may also be included in the downloaded interface. Still further, the downloaded interface may also reflect user-level customization by reflecting any modifications that users have made to the particular interface associated with the location-based device 108 selected at login.

Referring now to FIG. 4, another interface 120 is shown. The interface 120 may be presented to a user after logging into the system 100 and identifying the user's location-based device 108. The interface 120 may be a messaging interface and it may include a selection side 122 and a display side 124. The selection side 122 may include several options for selecting a user or a group of users to send a message to and options for including detail in a message. The display side 124 may include a rolling list of messages 126 that have been sent using the system 100 and directed toward the user's location-based device 108.

On the selection side 122, the interface 120 may include a series of interactive icons 128 for each of the role-based users 110 within a clinic. These icons 128 may be the icon or avatar that is stored in association with the role-based user 110 information discussed above. The interactive icons 128 may be used for purposes of sending one-touch messages and may function similar to a pager, for example, requesting that a selected role-based user 110 report to a location. The series of interactive icons 128 may include an icon for each role-based user 110 in the clinic 50. In the present embodiment, 12 interactive icons 128 are shown and each one is associated with a different role 110 in the clinic 50. In addition, navigation arrows 130 are shown pointing to the left and to the right allowing the window of interactive icons 128 to scroll to the left and to the right to reveal additional interactive icons 128.

Below the series of interactive icons 128, a message center 132 may be provided. The messaging center 132 portion of the interface 120 may be adapted to allow for more detailed messages than the one-touch portion of the interface 120. In this messaging center area 122, selection of a location-based device 108 to send a message to may prompt the user with an input field to enter the message and then the “submit” message button 134 at the bottom of the panel may be used to send the message. In addition, this portion of the interface 120 may include options for sending messages to a group 136 of location-based devices 108 in addition to a single location-based device 108. Groups may be created to include all or a portion of the location-based devices 108. For example, as shown, an “ALL” group button may be clicked on to open the group and the button may expand to reveal all location-based devices 108 in the clinic or all location-based devices 108 that are associated with a logged in user. Particular location-based devices within the group may be selected for sending a message or the entire group may be selected by selecting the “select all” option. As shown, other groups such as those associated with a particular dentist may be created. Still other types of groups may be created.

In some embodiments, the interface 120 may include worksheet options allowing a user to fill out a worksheet 138 to include in a message to another user. For example, the worksheet 138 may include data fields for notes, medical history, chief complaint, perio, and other pertinent information regarding the intake or initial screening of a patient. The worksheet 138 may be customizable to a particular practice allowing the user to create worksheets that capture information commonly communicated or otherwise valuable. As such, while the worksheet 138 shown may include information relating to dentistry, other dental practices may include other fields or questions on the worksheet 138. Still further, other practices outside of dentistry such as chiropractors, orthodontists, oncologists, or other office settings 50 may customize the worksheet 138 to include completely different fields including the number of fields and the type of information entered into the fields. While discussed in more detail below, FIG. 6 shows an example of what a resulting message 140 may look like that uses a worksheet 138. That is, as shown, the answers entered into the worksheet 138 may appear, one after another in the message 140 sent to the recipient. Referring back to FIG. 4, as shown, the interface 120 may include a submit button 134 for submitting a message, where, for example a series of entries have been entered for a worksheet 138 or, where, for example, a note or message is being entered together with a notification to another user.

As part of the detailed messaging aspect of the system 100, worksheets 138 may be any form that is desired to be viewed (i.e. patient information sheet, laboratory prescription, patient communication list, referral information), that may differ per provider. For example, one dentist may wish to have the hygienist list information on their page (changes in medical history, chief complaints, items discussed with patient, perio and restorative condition), where another provider may wish to have totally different information sent. The centralized database may allow users to customize these varied worksheets 138 easily, and then download them easily to individual devices. Worksheets 138 may be developed by creating each item (i.e. medical history), then allowing the user to define each item as “selectable”, “customized”, or “listable”. Selectable may refer to items that have a single response, but multiple yet definable options (i.e. male or female). Customized may refer to items that need to be written in (i.e. patient name). Listable may refer to items that multiple selections may occur from a list of definable items (i.e. items discussed—orthodontics, periodontics, restorative, whitening, personal information). The customized worksheet 138 may be used across multiple applications (intra-office communication, interoffice communication, laboratory prescriptions, patient communication).

Turning now to the display side 124 of the interface 120, a rolling list of all messages 126 that have been received by a device 108 may appear. As shown, for example, the user controlling the sterilization device 108E may have used a one-touch paging option to page the user at role OP6 110 to come to sterilization. In addition, the user controlling the BLP device may have used a one-touch paging option to page the DRL to come to the BLP station, for example. Each of these messages are shown in the rolling list side 124 of the display. It is noted that the present interface 120 is the interface 120 appearing on the sterilization device 108E. That is, in the upper left corner of the interface, it indicates “DEVICE: STER.” However, while the second message in the list is not related to sterilization, the message still shows up on the sterilization device 108E. This is because the paging icons 128 are set up to broadcast the message to a list of location-based devices 108 that are included at setup, while messages directed to particular devices 108 may be more selective. In other embodiments, the rolling list may include only messages 126 that are pertinent to the location-based device 108 displaying the interface 120. For example, the rolling list may include messages that have been sent to or from the location-based device 108 showing the interface 120 or in another example, the rolling list may include messages 126 that have been sent to or from a location-based device 108 by a user in a selected group. For example, a clinic 50 may be organized in teams under a dentist. As shown, a group may include Dr. Laskin or Dr. McKone. In some embodiments, the rolling list on location-based devices 108 controlled by users within Dr. Laskin's group may show messages to users within Dr. Laskin's group. Still other limitations and approaches may be taken to what is shown in the rolling list.

While a particular arrangement for the messaging interface 120 has been shown, it is to be appreciated that varying forms of the interface 120 may be provided depending on the type of computing device that is being used with the system 100. For example, the interface 120 of FIG. 4 may be suitable for a desktop, tablet, or other computing device with a relatively large screen. However, when the interface 120 is accessed with a smartphone, for example, the interface may be arranged slightly differently. For example, as shown in FIGS. 5-8, a same or similar level of functionality may be provided on a smartphone, for example. In this embodiment, as shown in FIG. 5, the one-touch paging portion of the interface may be shown and the message center 132 portion may be hidden and accessible by selecting the message center button 142. As shown in FIG. 6, the more limited selection portion of the interface may allow the display portion 124 of the interface 120 to be included such that the user can see messages on the relatively smaller smartphone screen. When the user desires to send a more detailed message, the user may select the message center button 142 which may present the user with the message portion 132 of the interface 120 as shown in FIG. 7. It is noted that this interface 132 may be compared to the message center portion 132 of the interface 120 shown in FIG. 4 and may appear very similar. This type of similar look may allow a user to switch between different types of computing devices and more quickly gain comfort with using the system 100. As shown in FIG. 7, the user may select the group for the front desk 144 and, in particular, may select ASST 146 from the group of interactive icons 128. This selection may prompt the user to enter a message or, as shown, a “next” button 148 may be provided prompting the user with an input box for a message or a worksheet 138 to fill out as shown, for example in FIG. 8. Upon submitting the message, the message 126 may appear on the ASST location-based device 108.

In addition to the variations in the interfaces based on the type of computing device, other interfaces may be used and, in some embodiments, the interfaces may be customized and/or personalized based on the user logged into the system 100 or the selected location-based device. That is, for example, the user may be able to select how little or how much messaging is shown on their respective location-based device. In other embodiments, colors, borders, or aesthetic options may be provided to a user. Still other customization and/or personalization options may be provided.

In addition to the user interfaces 120 shown, a series of interfaces may also be provided for use in setting up the system 100. That is, these interfaces may allow a user to enter information about the number and type of location-based devices 108 that are suitable for a given clinic 50 and may also allow the user to enter information about the several role-based users 110 in the clinic 50. As shown in FIG. 9 a user interface 150 may be provided for adding devices to a particular client's system 100. As shown, the interface may include an entry for a device name, a short name, a device type, an icon color, and a device icon. As shown in FIG. 10, the data structure 152 for several devices 108 is shown after a user, for example, has added several devices 108. FIG. 11 includes an interface 154 for adding role-based users 110. As shown, the interface 154 may include an entry for a name, a short name, an icon color, an ordered (for defining the order of appearance of items), an avatar or icon selection, a device tone, a series of radio buttons allowing for the selection of associated devices 108. The selection of these radio buttons defines the appearance of the interactive icons 128 that appear on a the several devices 108 once they log in. FIG. 12 includes yet another setup type interface 156 allowing for pre-written messages to be input into the system 100 for later selection by a user when the user is sending a message 126 with the system 100.

The above system 100 may be advantageous for several reasons. For example computing, a device may be any computing device that can be logged into (i.e. PC, Mac, iPod, iPhone, iPad, Android device). As such the system 100 may help avoid the need to distinguish between device types, as all communication can flow between each other. For example “Dr. Johnson” may log in using an iPhone one day, and a PC the next.

As mentioned, the system may include data structures defining the several algorithms performable by the system 100 in response to being accessed by a user and interacted with by a user. These algorithms or parts thereof are apparent from the more detailed discussion of use of the system 100 below.

Referring now to FIG. 13, in one embodiment a method 200 performed by the system 100 may include receiving login information 202. The system may perform a credential check and or identify the user 204. The system may then prompt the user to select a location-based device with which they are associated 206. The system may then push, or cause to be downloaded, an interface particular to that location-based device 108 and particularly adapted for the type of computing device the user is using 208. For example, in some embodiments, the user interface 120 may be different for some location-based devices 108 within a given client or the interface 120 may be the same for all location-based devices 108 within a client. In other embodiments, the interfaces 120 for the several location-based devices 108 may start out the same and may be customized or modified by the users over time. Still further, the system 100 may dynamically adapt to show all of its parts and pieces on a larger screened devices such as desktops, laptops, or ipads, and may be adapted to show lesser parts and pieces on iphones or smaller screened smartphones, for example. In the case of showing lesser parts and pieces of the system, the interface 120 may have drop downs or menu buttons for accessing other aspects of the interface 120.

The system 100 may be used particularly for intraoffice communication and, as such, in one embodiment, the system 100 may receive input regarding a page to be sent to a role-based user 210. In the context of a one-touch page, the system may identify 212 and broadcast the page to all of the location-based devices 108 that the receiving user has identified in the setup process 214. That is, if, for example, the doctor selected the doctor's office, operatory I, operatory II, and front desk to be associated with his/her role-based user 110, then the system 100 may display the page 126 on the interface 126 for each of these devices 108. The content of the page may be automatically defined by the location-based device 108 where the page 126 was initiated and the role-based user 110 that was attempted to be contacted (i.e., Dr. Bob's icon is pressed on OP1 device may cause “Dr. Bob to OP1.”). Additional messaging and/or paging may be processed by the system 100 and additional pages or messages 126 may appear below the previous message until messages are cleared. For example, when visited by Dr. Bob, the user in OP1 may touch the page 126 on the screen, which may cause it to disappear or otherwise be cleared 216. In other embodiments, the user may swipe the message 126 clear or otherwise delete the message 126. In either case, the system 100 may receive input to clear the message 216 and the system 100 may take action to clear the message 218.

In other embodiments, the system 100 may receive an indication that a detailed message 126 is to be sent 219 such as when a user selects a device or group in the message center. In this context, the system may prompt 220 the user with optional pre-entered messages to include in the message or the system may prompt the user to type in a message. In other embodiments, the user may be prompted to fill out a worksheet or may have the option to select a worksheet to fill out. The system may receive additional input 222 (i.e., a message selection, text entry, or field data from the worksheet) from the user. The system 100 may then present the message 126 to another user and/or those affiliated with the another user by identifying 224 which location-based device 108 the user associated with at login and displaying the message on the device 226. In the context of a message 126 to a user, the receiver of the message 126 may select the message and be prompted with a series of response options or a “message received” reply may be sent by clicking or touching on the message 126. Once the another user responds to the page, the another user may clear the message by closing it on his/her interface 120.

Referring now to FIG. 14, a user or series of users may interact with the system 100 in several ways. For example, the user may log on to the system with any computing device having access to the network (e.g., the Internet) 302. Having identified themselves via logging in, the system may present them with an interface that may be adapted by the user for their particular purpose and may be further adapted for the type of computing device they are using. Once logged in, the user may select which location-based device 108 they are associated with 304. For example, a hygienist may be in operatory 1 and upon logging in, the hygienist may select operatory 1 as his or her device or station. On the other hand, Dr. Jones may log in with his or her login information and may select as his or her device such as doctor's office or Dr. Jones' office. Accordingly, each point of login to the system may be affiliated with a location-based device 108. In each case, upon selecting the location-based device 108 of choice, the user's computing device may download the associated interface 120 that reflects the client-level customization and the user-level customization.

Having accessed the system 100, users may be able to page a particular person to a particular location with a one touch process including touching the person's icon 128 on a user interface 120 of a computing device that is logged onto the system 306. Touching the person's icon 128 may trigger a message 126 on the system calling for the person represented by the icon 128 to physically go to the location of the location-based device 108 where the page was sent. For example, a device logged onto the system and identified as “operatory 1” may be used to call a dentist in to examine the teeth of a patient who just finished having his or her teeth cleaned. That is, a hygienist, for example, may log on to the system using his or her username and password. Upon logging on, the hygienist may select the operatory 1 device. Having done this, if the hygienist touches the icon 128 of Dr. Jones, the dentist, this may trigger a message 126 on the system 100 to all devices 108 associated with Dr. Jones' paging icon 128 causing the page (calling Dr. Jones to go to operatory 1 to examine a patient's teeth) to appear in the respective display area 124 of these devices 108. Once the doctor has arrived to review the teeth cleaning, the hygienist, for example, may select the page in the display area 124 to clear the message 308.

In addition to one-touch paging, a user may send a more detailed message 126 to another user. Depending on the nature of the user's computing device, this may involve navigating to another interface such as a message center 310. In the message center 132, the user may select a device or group of devices to send a message to 312. Again, depending on the nature of the computing device, the user may select next 148 to indicate a desire to compose or select a message 314. The system may prompt the user to select one of several pre-written messages that, for example, were previously entered in the interface shown in FIG. 12. In other embodiments, the system may prompt the user with a text box so the user can type a message 126. In other embodiments, the user may fill out a worksheet 138, or have the option to select a worksheet 138 to fill out, including several pieces of information about a patient, for example. The system may be configured to give the user all of these options and once selected, the user may provide the respective input 316. Having provided the input, the user may also depress a submit button 134, for example, to send the message 126. The message 126 may then appear on the selected location-based devices 108.

In some embodiments, emergency notification may be provided. For example, a ER icon may be provided and when touched, a confirmation may be requested. Upon confirmation by the user an alarm may be sounded throughout all (or select) devices. This may be an auxiliary notification, for example, which may be used together with calling an emergency number such as 911 or otherwise calling for help or support.

It is to be appreciated that while some of the data structures in the described system are referred to as location-based devices 108 and role-based users 110, that this label has been relied on for purposes of explanation in the context of a dental or other clinic practice 50, for example. However, due to the high level of customization available in the described system 100, a client 50 may choose to customize these items in any fashion by labeling them with long and short names and configuring them using the interfaces of FIGS. 9 and 11. In light of this, it is to be appreciated that a client 50 may not name the devices based on location and may not name the users based on roles. On a basic level, the location-based devices 108 may merely be identifiable interfaces 160 and the role-based users 110 may be an input element 162 associated with one or more of the identifiable interfaces 160.

As shown in FIG. 15, for example, several identifiable interfaces 160 are numbered 1-4 and several input elements 162 are labeled A-D. It is to be appreciated that the identifiable interfaces 160 shown have a paging area where icons 128 associated with the input elements 162 are shown and a messaging area where groups are identified including one or more of the identifiable interfaces 160 1-4.

With continued reference to FIG. 15, each of the input elements 162 is associated with one or more of the identifiable interfaces 160. Upon actuation of an input element 162 (i.e., by pressing an image icon on any of the interfaces), a notification may be sent to all of the input element's associated identifiable interfaces 160. For example, if the icon form the input element ‘A’ was pressed on any of the identifiable interfaces, then a page would appear on identifiable interfaces 1 and 2. As may be appreciated from the above discussion, the names of the input elements 162 and the interfaces 160 they are associated with, among other things, are customizable by the client. However, to be effective, the system 100 may be set up by a client such that a “person user” reflected by the name of the input element 162 is likely to view one of the identifiable interfaces 160 that the input element 162 is associated with. This way, when the input element 162 is actuated, the intended person user may have a high likelihood of seeing the message 126. In contrast to the broadcast type messaging associated with the input elements 162, the identifiable interfaces 160 may communicate directly with one another on a one-to-one basis or by relying on established groups. Like the input elements 162, the names and details of the identifiable interfaces 160 are completely customizable. However, to be effective, the system 100 may be set up by a client 50 such that the names of the identifiable interfaces 160 reflect the location, role, or other attribute, such that the messages 126 being sent to the identifiable interfaces 160 may be appropriate and/or tailored for the person user of that interface 160. As such, while the above system has been described with respect to location-based devices 108 and role-based users 110, it can be seen that the customization of these data structures may allow for them to be named or labeled on other bases besides location/role.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A clinic management system, comprising:
a computing device in communication with a network, the computing device comprising:
a computer readable data storage medium having data structures stored thereon for facilitating communication in a clinic, the data structures comprising:
a clinic identifier;
a list of location-based devices in the clinic;
a list of role-based users affiliated with the clinic; and
a user interface configuration including:
a one-touch interactive icon for each role-based user;
a message generation area allowing detailed messages to be sent to a location-based device;
a messaging area for displaying messages sent by the system; and
an algorithm for facilitating communication between the location-based devices; and
a processor configured for:
processing downloads over the network of user interfaces for at least a portion of the location-based devices in the list of location-based devices, the user interfaces being based on the stored user interface configuration, setup information provided by the clinic, a selected location-based device, and at least a portion of the role-based users, wherein, upon selection of a one-touch interactive icon for a selected role-based user, a message is generated on at least one location-based device calling the role-based user to the location associated with the message;
displaying the message on the location-based device.

2. The clinic management system of claim 1, wherein the message generation area comprises an icon for at least one location-based device.

3. The clinic management system of claim 2, wherein the message generation area comprises a group of icons for location-based devices.

4. The clinic management system of claim 2, wherein the data structures further comprise a plurality of data entry fields to be filled out by a user when sending a message to a location-based device.

5. The clinic management system of claim 4, wherein the plurality of data entry fields are in the form of a worksheet.

6. The clinic management system of claim 5, wherein the worksheet is customizable by the user.

7. The clinic management system of claim 2, wherein the data structures further comprise a list of pre-written messages to be selected from by a user when sending a message to a location-based device.

8. The clinic management system of claim 1, wherein the list of location-based devices is customizable by a user.

9. The clinic management system of claim 8, wherein the location-based devices comprise a name and an icon.

10. The clinic management system of claim 1, wherein the list of role-based users is customizable by a user.

11. The clinic management system of claim 10, wherein the role-based users comprise a name, an icon, and an associated location-based device.

12. The clinic management system of claim 11, wherein the role-based users comprise a plurality of associated location-based devices.

13. The clinic management system of claim 12, wherein the user interface is customizable by a user.

14. A method of managing a clinic, comprising:
uploading, over a network and for download by a computing device, an interface;
communicating with the computing device to receive inputs from the interface and send outputs for display on the interface,
wherein, the interface is for a location-based device and comprises:
a plurality of interactive icons for each of a plurality of role-based users;
a messaging area for displaying messages sent by the system; and
an indication of which location-based device the interface is being displayed on;
associating a role-based user with at least one location-based device;
receiving a selection, via the network and the interface on the location-based devices, of one of the interactive icons;
compiling a message directed toward the at least one location-based device that is associated with the selected interactive icon;
displaying the message, via the network, on the at least one location-based device.

15. A method of managing a clinic with a clinic management system and performed by a first user having a role in the clinic and performing that role at a first location, the method comprising:
accessing a network with a computing device;
navigating to and logging into a website of a clinic management system;
selecting, by the first user, a location-based device from a list of location-based devices;
using an interface having a plurality of interactive icons associated with other users in the clinic, comprising:
requesting a second user to report to the first location; and
inputting a verbal message and sending the verbal message to one or more users,
wherein, requesting a second user to report to the first location consists of selecting an interactive icon, of the plurality of icons, associated with the second user.

16. The method of claim 15, wherein inputting a verbal message comprises typing text for a message.

17. The method of claim 16, wherein inputting a verbal message comprises filling out a plurality of fields on a worksheet.

18. The method of claim 15, further comprising customizing the interface.

19. The method of claim 15, further comprising establishing the list of location-based devices in a set up process.

20. The method of claim 15, further comprising establishing a list of role-based users associated with the plurality of interactive icons and including a list of associated location-based devices.
